(19) United States
(12) Patent Application Publication
(10) Pub. No.: US 2007/0133556 A1
(43) Pub. Date: Jun. 14, 2007

(54) System and method of distributed intelligent scheduling with compensation optimization (DISCO) for wireless ad hoc or personal area network

(76) Inventors: Quan Long Ding, Hong Kong (CN); Zuyuan Fang, Hong Kong (CN); Witty Wong, Hong Kong (CN); Peter Diu, Hong Kong (CN)

Correspondence Address: KNOBBE MARTENS OLSON & BEAR LLP, 2040 MAIN STREET, FOURTEENTH FLOOR, IRVINE, CA, 92614, US

(21) Appl. No.: 11/298,896

(22) Filed: Dec. 9, 2005

(51) Int. Cl. H04L 12/56

(52) U.S. Cl. 370/395.4

(57) ABSTRACT

A system of distributed intelligent scheduling with compensation optimization (DISCO) for a wireless ad hoc network or a personal area network is provided. The system schedules packet transmissions for a plurality of links within the network based on link information which includes QoS requirement, achieved QoS and channel status for the links. The channel status is classified as a good mode, a bad mode and a marginal mode based on successful packet transmission probability. The successful packet transmission probability of the good mode is greater than the successful packet transmission probability of the marginal mode, while the successful packet transmission probability of the marginal mode is greater than the successful packet transmission probability of the bad mode.

### FIELD OF THE INVENTION

The present invention relates generally to wireless communication. More particularly, the present invention relates to a distributed intelligent scheduling method and system for wireless ad hoc or personal area network.

### BACKGROUND

Wireless communication between wireless terminals has become increasingly popular. There are essentially two techniques used for linking terminals in wireless networks. The first technique uses infrastructure networks, which are essentially systems of repeaters where the transmitting or originating terminal contacts a repeater and the repeater retransmits the signal to allow for reception at the destination terminal. The drawbacks to the infrastructure systems include significant costs and geographic limitations. Because of the significant costs, it is not practical to have infrastructure networks in all areas. Furthermore, in times of emergency, such as earthquake, fire, or power interruption, the infrastructure network can become disabled in the precise location where it is needed most.

The second technique for linking terminals is to form a wireless ad-hoc network among all users within a limited geographical region. The wireless ad-hoc network generally includes a collection of wireless terminals that communicate with each other using radio frequency links. These terminals communicate through shared spectrum and access the medium in a distributed manner. Each user participating in the ad-hoc network should be capable of, and willing to, forward data packets and participate in ascertaining if the packet was delivered from the original source to the final destination. The wireless ad-hoc network has a number of advantages over infrastructure networks. For example, the wireless ad-hoc network is more robust, in that it does not depend on a single terminal, but rather has a number of redundant, fault tolerant, terminals, each of which can replace or augment its nearest neighbors. Additionally, the ad-hoc network can change position and shape in real time. Due to its high flexibilities, the wireless ad hoc network is widely used in both military and civilian applications.

As a special type of the ad hoc network, wireless personal area network (WPAN) tries to establish wireless communications between mobile devices carried by person, home electronics equipment and personal computers and peripherals. The communication range for a WPAN is restricted in a small area, typically 10 m in omni-directions.

Provisioning quality of service (QoS) is important for wireless ad hoc and personal area networks. In a networking protocol stack, an efficient medium access control (MAC) scheme plays an important rule in provisioning QoS. The MAC scheme should guarantee a packet transmission to be successful as possible as it can. In general, even when a time period is reserved for a packet, a MAC scheduler can only guarantee the packet to be delivered from a source to a wireless radio channel without collision with other packets. The MAC scheduler, however, cannot guarantee that the packet is successfully received by the destination. This is because the wireless radio channel is a time varying and error-prone channel. Therefore, in order to provide QoS, it is necessary to take the quality of the radio channel into consideration when setting up the MAC scheduler.

Currently, the distributed coordination function (DCF) defined in IEEE802.11 standard is widely adopted as the MAC protocol for ad hoc networks. However, the DCF is a random access protocol and has a fairness problem. As such, it cannot provide better QoS. Many schemes have been proposed or developed to improve the fairness property. However, most of these schemes are based on the random channel access schemes: channel access opportunity is adjusted and affected by packet loss which may be caused by the combination effect of packet contention and radio channel errors.

There are two MAC schemes for high-speed WPANs, namely, IEEE802.15.3 proposed by IEEE and WiMedia MAC proposed by WiMedia Alliance. Both schemes adopt a hybrid of time division multiple access (TDMA) and random access mechanism to provide better QoS for multimedia applications. IEEE802.15.3 is a centralized scheduling scheme where a WPAN is divided into a set of Piconets. In each Piconet, one wireless terminal is selected as the central control unit called Piconet coordinator (PNC). The PNC provides basic timing through beacon and coordinates access control in the Piconet. On the contrary, WiMedia MAC is a distributed scheme where logical groups are formed around each wireless terminal to coordinate medium access control. The basic timing of the system is a super frame, which is further divided into a beacon period and a data period. In the beacon period, each wireless terminal selects a time slot to send its own beacon, which is used to exchange control information and form the logical group. The data period is divided into a series of medium access slot (MAS). A MAS is either reserved by a wireless terminal through distributed reservation protocol (DRP) or left for contention access by prioritized channel access (PCA) protocol. For each wireless terminal, the time to be reserved is determined by the upper layer QoS requirement.

Some schemes that schedule channel access based on channel status have been proposed for wireless LANs and wireless cellular networks. For example, the schedule can be made based on priorities, which are the functions of channel condition and fairness criteria. Scheduling schemes can also consider channel status and QoS requirement. In addition, a semi-distributed scheme can be used to make transmission schedule in both access point and wireless terminals based on the traffic classification and channel status. However, these schemes need a central control unit to run the scheduler. The central control unit is also responsible for information collection. Further, the channel status is reported to the central control unit by each wireless terminal. As such, this type of control scheduler is not suitable for decentralized wireless networks.

The accuracy of channel status is crucial for channel access scheduling. Due to the time varying property of the wireless channel, the status reported by wireless terminals may be outdated for the next transmission. To have more accurate channel status, channel prediction mechanisms have been developed for wireless LANs and wireless cellular networks. For example, channel history information can be stored and used for channel status prediction. However, this scheme conducts channel status prediction in a very large time scale and aims to predict routes for users in wireless cellular networks.

In summary, most of the current schemes are centralized ones which are not suitable for the ad hoc networks because the ad hoc networks have distributed network architectures. Therefore, it is desired to develop a scheduling system and method based on predicted channel status, upper layer QoS requirement, and achieved QoS in a totally distributed manner.

### SUMMARY

A system of distributed intelligent scheduling with compensation optimization (DISCO) for a wireless ad hoc network or a personal area network is provided. The system schedules packet transmissions for a plurality of links within the network based on link information which includes QoS requirement, achieved QoS and channel status for the links. The scheduling is achieved through quantizing quality of a radio channel of each of the links by classifying a first or good mode, a second or bad mode, and a third or marginal mode of the channel status based on successful packet transmission probability. The successful packet transmission probability of the good mode is greater than the successful packet transmission probability of the marginal mode, while the successful packet transmission probability of the marginal mode is greater than the successful packet transmission probability of the bad mode.

When the channel status of a link is in the bad mode, the allocated time slots of the link are taken by other links with better channel conditions at that time. When the channel status of the link changes from the bad mode to the good mode or the marginal mode, bandwidth compensation will be conducted to maintain fairness. When a link with channel status in the bad mode, fewer packets are transmitted via the link. In order to maintain fairness, more packets will be transmitted later via the link. This is achieved by maintaining the achieved QoS. Since the link has worse achieved QoS after its channel status recovers, it will be allocated more transmission opportunities to achieve better QoS. When the channel status is in the marginal mode, DISCO system tries to assign more bandwidth to the link so that it can use more powerful error correction method to improve its QoS performance. In addition, DISCO system also considers the QoS requirement and the achieved QoS. Accordingly, DISCO system is able to improve both QoS and overall network bandwidth utilization.

In one embodiment, the DISCO system includes a scheduler, a radio channel status predictor, an aggregator, a broadcaster, a channel quality monitor, and a data storage device. The scheduler is used for developing a transmission schedule for a plurality of links within the network based on link information which includes QoS requirement, achieved QoS and channel status for the links. The radio channel status predictor is used for predicting the channel status for the links. The aggregator is used for aggregating the QoS requirement, the achieved QoS and the channel status for links as a link information message. The broadcaster is used for broadcasting the link information message. The channel quality monitor is used for detecting channel quality, computing achieved QoS, overhearing and collecting the link information. The data storage device is used for storing the link information.

### BRIEF DESCRIPTION OF THE DRAWINGS

FIG. 1 is a diagram illustrating a typical wireless ad hoc or personal area network.

FIG. 2 shows the components of a scheduling unit of the DISCO scheme.

FIG. 3 shows one embodiment of an outgoing link processing unit of the scheduling unit of FIG. 2.

FIG. 4 shows one embodiment of an incoming link processing unit of the scheduling unit of FIG. 2.

FIG. 5 shows the relationship between the bit error rate (BER) and the distance between the sender and the receiver.

FIG. 6 shows the relationship between the signal to noise ratio (SNR) and the distance between the sender and the receiver.

FIG. 7 shows the relationship between the BER and the SNR.

FIG. 8 shows the format of a link information message.

FIG. 9 is a flowchart illustrating the DISCO scheme.

FIG. 10 is a flowchart of the initialization procedure of the DISCO scheme.

FIG. 11a shows a main control flow of the scheduling procedure of the DISCO scheme.

FIG. 11b shows a detailed control flow of the scheduling procedure of the DISCO scheme.

FIG. 12 illustrates the implementation of the DISCO scheme with WiMedia MAC.

### DETAILED DESCRIPTION OF CERTAIN EMBODIMENTS

Reference is now made in detail to certain embodiments of the invention, examples of which are also provided in the following description. Exemplary embodiments of the invention are described in detail, although it will be apparent to those skilled in the relevant art that some features that are not particularly important to an understanding of the embodiments may not be shown for the sake of clarity.

Furthermore, it should be understood that the invention is not limited to the precise embodiments described below and that various changes and modifications thereof may be effected by one skilled in the art without departing from the spirit or scope of the invention. For example, elements and/or features of different illustrative embodiments may be combined with each other and/or substituted for each other within the scope of this disclosure and appended claims.

In a wireless ad hoc network, wireless terminals communicate with each other directly or through intermediate terminals. It is assumed that every wireless terminal is equipped with only one omni-directional antenna and one wireless terminal cannot send and receive simultaneously. The scheduling scheme targets an ad hoc network or a personal area network in which all wireless terminals are within the communication ranges of other terminals. Therefore, all wireless terminals can overhear each other. At one time period, only one transmission can be successful, and all other wireless terminals can overhear this transmission. Under these conditions, if a packet transmission is not successful, the failure should be caused by radio channel error. Therefore, the contention status is decoupled from the radio channel error. Further, since global information needs to be collected, if all wireless terminals are within each other's range, it is easy for them to monitor and collect global information. However, for a multi-hop network, by adopting an efficient global information propagation mechanism, the scheme also applies.

In general, scheduling refers to assigning a set of tasks to a set of resources subject to a set of constraints. As used herein, scheduling refers to allocating transmission time (resource) to a link (task) based on certain requirements (constraint).

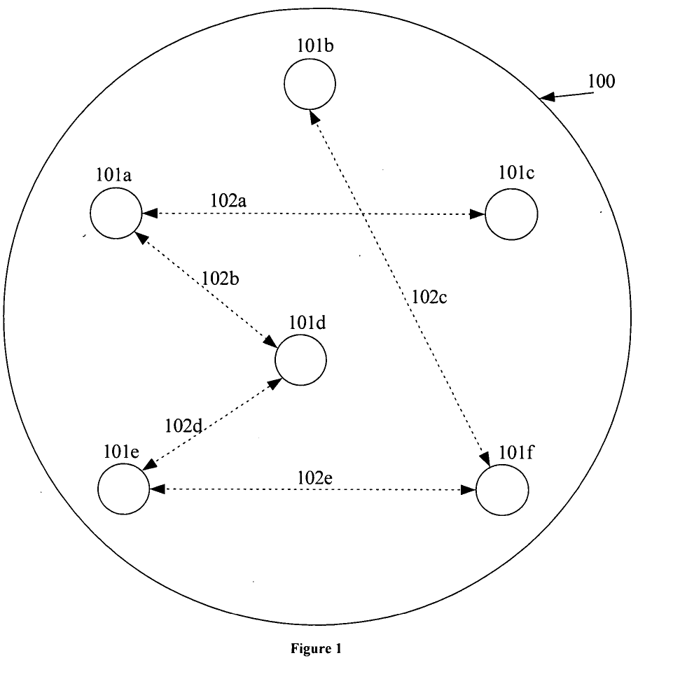

Referring now to FIG. 1, a typical wireless ad hoc or personal area network 100 is shown. The network 100 includes a set of wireless terminals 101a-101f, which can overhear each other. A link can be established between any two wireless terminals, such as links 102a-102e shown in the figure. One wireless terminal can establish multiple links.

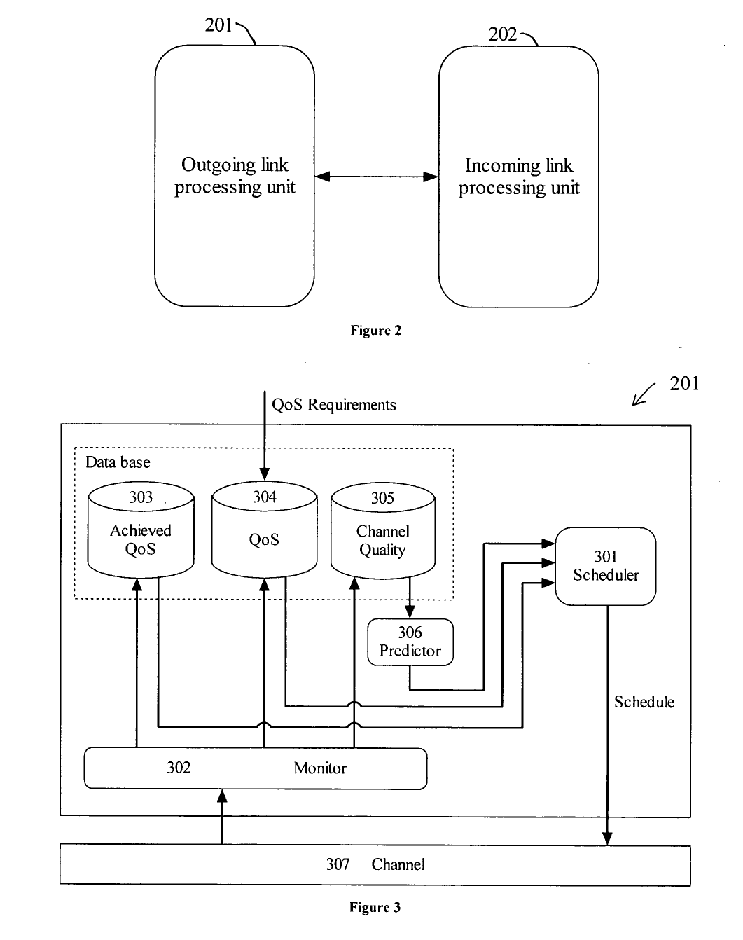

A wireless terminal has two types of local links, namely, an outgoing link if it serves as the sender and an incoming link if it serves as the receiver. It takes different actions on different kinds of links. The scheduling unit of the DISCO scheme can be divided into two sub-processing units, namely, an outgoing link processing unit 201 and an incoming link processing unit 202, as shown in FIG. 2. Each wireless terminal can have a scheduling unit which makes transmission schedules independently. The outgoing link processing unit 201 can be used for link information collection and channel access scheduling, while the incoming link processing unit 202 can be used for broadcasting link information for all local links, monitoring channel status and measuring achieved QoS for all local incoming links. Alternatively, the scheduling unit can have only one processing unit which has the functions of the outgoing link processing unit 201 and the incoming link processing unit 202 as discussed above.

Referring now to FIG. 3, one embodiment of the outgoing processing unit 201 of FIG. 2 includes a channel status predictor 306, a scheduler 301, a channel quality monitor 302, and a date storage device (e.g., databases 303, 304 and 305) in the illustrated embodiment. The main tasks of the outgoing processing unit 201 include but are not limited to overhearing all link information, updating databases, predicting channel status, and setting up a schedule for all links based on the prediction. The monitor 302 can be used for collecting link information by overhearing and updating databases. The databases 303, 304 and 305 can be used for maintaining achieved QoS, QoS requirement and radio channel status. The predictor 306 can be used for channel status prediction. The channel prediction method can depend on the techniques adopted by the underlined physical channels. Different prediction methods, such as Kalman-filter or maximizing likelihood method, can be adopted to predict radio channel status. The scheduler 301 can be used to set up transmission schedules based on global link information. The global link information is link information for all links in a whole network. Although the exemplary outgoing processing unit is described herein, it is to be understood that other types of outgoing processing units can also be used as the sub-processing unit of the scheduling unit of the DISCO scheme.

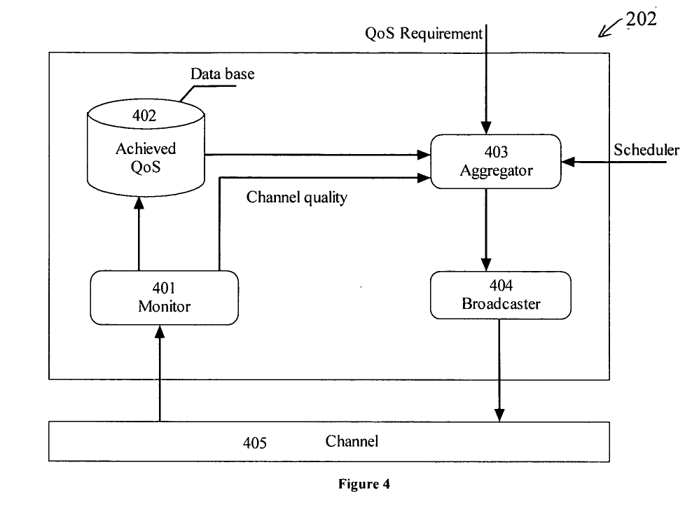

Referring to FIG. 4, one embodiment of the incoming processing unit 202 of FIG. 2 includes a channel quality monitor 401, an aggregator 403, a broadcaster 404 and a date storage device (e.g., database 402). The main tasks of the incoming processing unit 202 include but are not limited to monitoring channel status, computing achieved QoS for each incoming link, generating a link information message by aggregating channel status and achieved QoS for all incoming links together with QoS requirements for all outgoing links, and broadcasting this message. The monitor 401 can be used to detect achieved QoS and monitor channel status. The database 402 can be used to maintain history information to measure the achieved QoS. The aggregator 403 can combine the achieved QoS and radio channel status for all local incoming links together with QoS requirements of all local outgoing links as one message, which is referred as link information message. The link information message can be sent to the channel 405 by the broadcaster 404. Although the exemplary incoming processing unit is described herein, it is to be understood that other types of incoming processing unit can also be used as the sub-processing unit of the scheduling unit of the DISCO scheme.

The DISCO scheme is a link based scheduling scheme, which sets up transmission schedules for each link instead of a wireless terminal. The scheme can schedule packet transmission based on global link information. The link information includes channel status, QoS requirement and achieved QoS. Channel status refers to the physical radio channel status which does not include contention status. The QoS can be measured as throughput, delay, delay jitter, fairness or any other metrics. The achieved QoS is the actual QoS performance of the link. The QoS requirement can be set up by the upper layer. For example, for real time traffic, the upper layer may specify the bandwidth requirement explicitly or the delay requirement, which can be further converted to the bandwidth requirement. The achieved QoS can be measured by the receiver.

The channel status is quantization of channel quality, which can be classified as three modes: a first or good mode, a second or bad mode, and a third or marginal mode. The good mode is determined when the radio channel is in good status such that the successful packet transmission probability is very high. For example, when the successful packet transmission probability is greater than 95-99%, preferably 97%, the channel status is classified as the good mode. The bad mode is determined when the radio channel is in bad status such that the successful packet transmission probability is very low. For example, when the successful packet transmission probability is less than 90-99%, preferably 95%, the channel status is classified as the bad mode. The marginal mode is determined when the radio channel is in a status such that the successful packet transmission probability is average. For example, when the successful packet transmission probability is greater than or equal to 90-99%, preferably 95%, but less than or equal to 95-99%, preferably 97%, the channel status is classified as the marginal mode. The successful packet transmission probability of the good mode is greater than the successful packet transmission probability of the marginal mode, and the successful packet transmission probability of the marginal mode is greater than the successful packet transmission probability of the bad mode. For example, in some embodiments, the good range is 95-99%, the marginal range is 92-94.9% and the bad range is less than 92%.

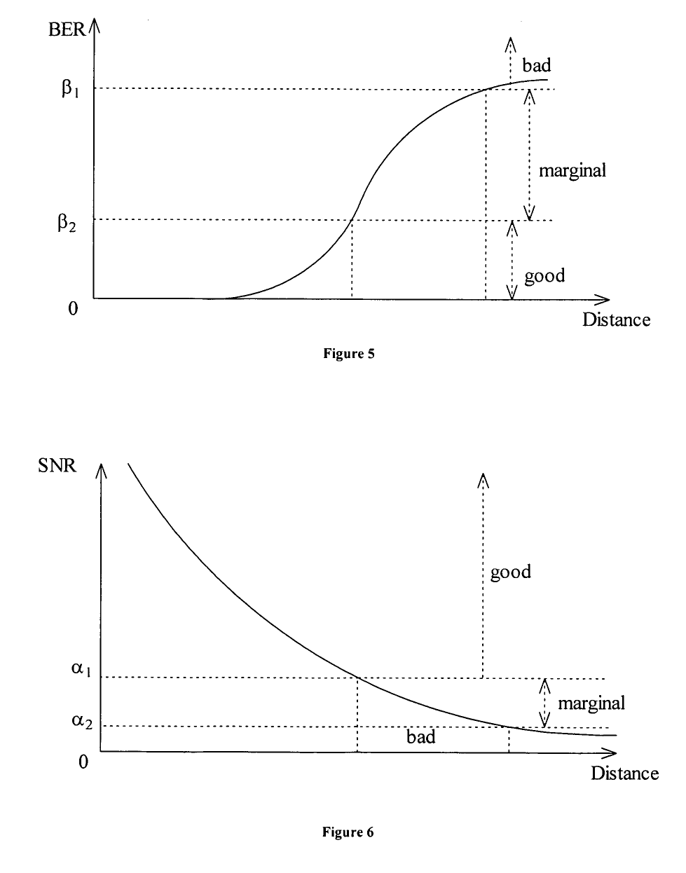

The channel status can be measured by the bit error rate (BER) of a radio channel. Two thresholds β₁ and β₂ (β₁>β₂) of the channel quality signal can be defined for the classification. The value of β₁ and β₂ depend on the application requirements. For example, β₁ can be picked in the range of about 10⁻⁴ to about 10⁻¹, while β₂ can be picked in the range of about 10⁻⁹ to about 10⁻² Preferably, β₁ is set as about 10⁻², while β₂ is set as about 10⁻⁴. When the BER is less than β₂, the channel status is classified as the good mode. When the BER is greater than β₁, the channel status is classified as the bad mode. When the BER is greater than or equals to β₂ but less than or equals to β₁ the channel status is classified as the marginal mode. BER is determined by a number of parameters, such as the distance between the sender and the receiver, data rate, etc. Among these parameters, the distance is one important parameter. FIG. 5 shows the relation between BER and the distance for a wireless channel (assuming that all other parameters are fixed). If β₁ and β₂ are selected, the channel status can be determined accordingly.

In a real system, BER is measured as the number of bit error over the number of bits received in a measurement time. To have more accurate measurement, the measurement time should be long enough to achieve a realistic statistical probability. However, the DISCO scheme utilizes a channel quality measurement method. Therefore, as an alternative, the channel status can be measured by signal to noise ratio (SNR). SNR is the ratio of the received signal strength over the noise strength in the frequency range of the operation. When a packet is successfully received, its SNR can be measured immediately. The larger the value of the SNR, the better the channel quality. Referring to FIG. 6, two thresholds α₁ and α₂ (α₁>α₂) can be defined to classify the channel status. When the SNR is greater than α₁ the channel status is classified as the good mode. When the SNR is less than α₂, the channel status is classified as the bad mode. When the SNR is less than or equal to α₁ but greater than or equal to α₂, the channel status is classified as the marginal mode. The values of α₁ and α₂ depend on the predefined BER thresholds.

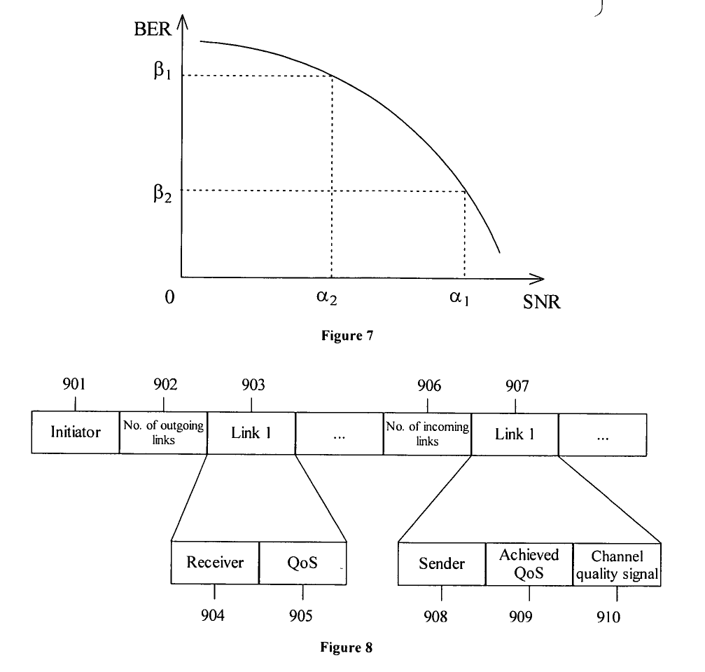

In general, the relationship between SNR and BER depends on a modulation scheme. A SNR versus BER curve can be found by simulations to determine two thresholds of the SNR signal. The typical relation between BER and SNR is shown in FIG. 7. If the relation between SNR and BER is found, α₁ and α₂ can be determined based on β₁ and β₂.

Although BER and SNR of a radio channel have been used to measure the channel status, it is to be understood that other types of methods can also be used to measure the channel status, including but not limited to using signal strength, packet error rate, etc.

In the scheduling unit, the channel status can be stored in terms of the value of channel quality signal. The new value of channel quality signal of a link can be predicted by the predictor. The future channel status of the link can be classified by this value. The channel status database can maintain channel status for all links. The database also keeps history information. The duration of the history information can depend on the requirements of the prediction method.

The DISCO scheme depends on global link information. Such information can be obtained from the wireless terminal where each terminal broadcasts the link information periodically. Although all wireless terminals are within the transmission ranges of other terminals, one terminal sometimes may not correctly receive link information messages from other terminals due to channel errors. This problem can be solved by repeatedly broadcasting the link information messages.

The scheduling scheme is also invoked periodically. Within the scheduling period, the link information message is broadcast at least once. The link information message may be broadcast in a more reliable period compared with that of data packets if the network permits. For example, the link information message can be sent at lower data rate, while normal data can be sent at a higher data rate in the same channel.

FIG. 8 shows the format of the link information message. The incoming link processing unit can aggregate the achieved QoS and the channel status information for local incoming links and the QoS requirement for local outgoing links as one message. The message can include an initiator 901, the number of local outgoing links 902, a message item for each outgoing link 903, the number of incoming flows 906, and a message item for each incoming link 907. Each outgoing link 903 can include a receiver of the link 904 and a QoS requirement 905. Each incoming link 907 can include a sender of the link 908, an achieved QoS 909 and a current value of channel quality signal 910.

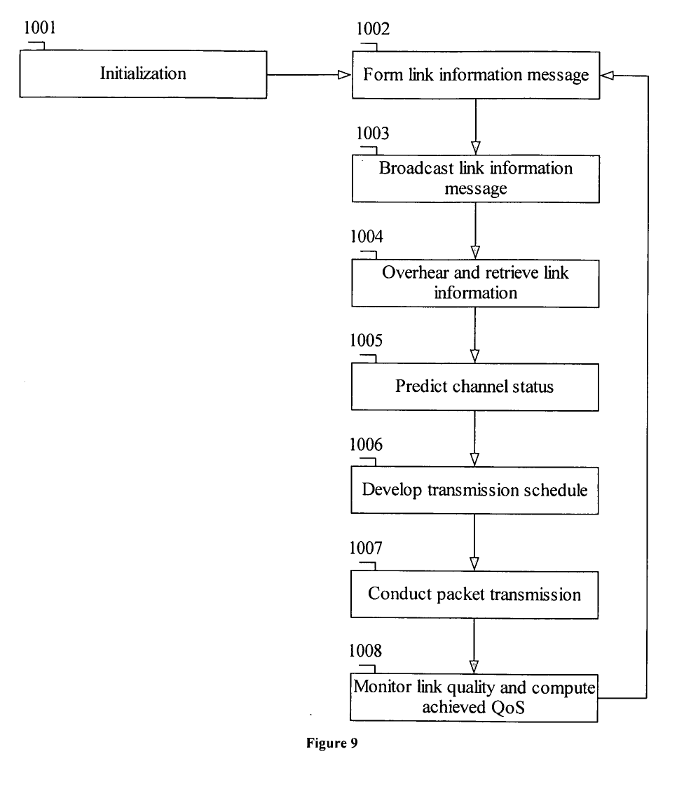

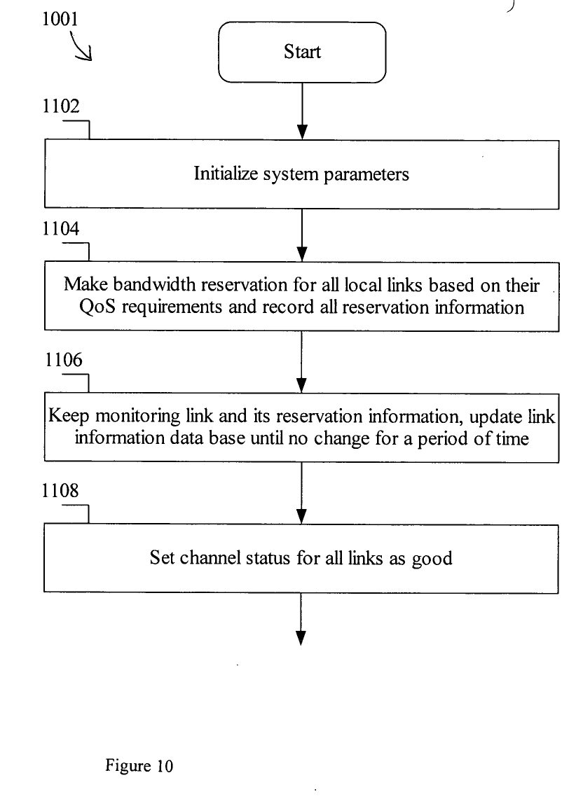

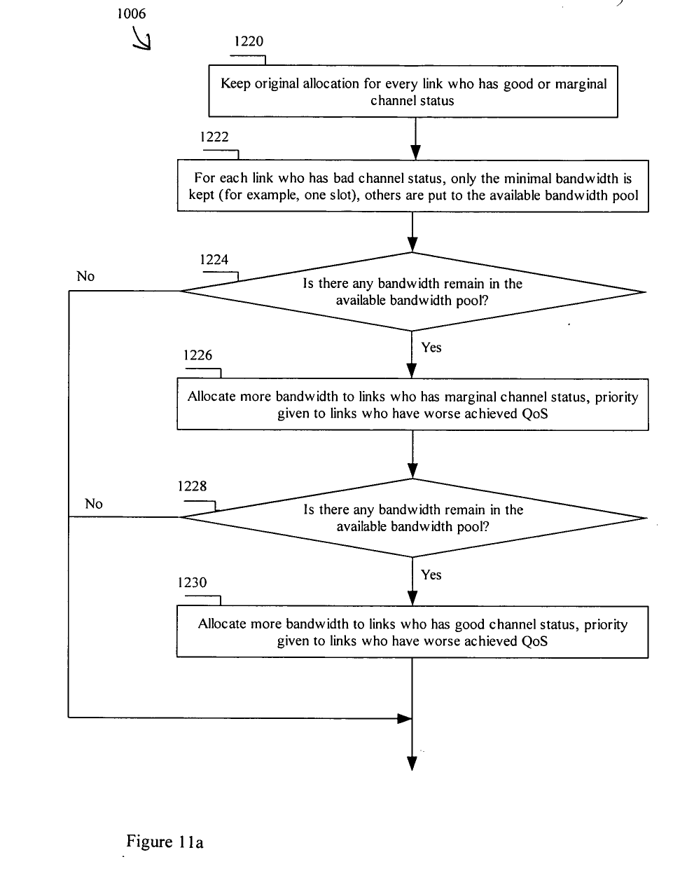

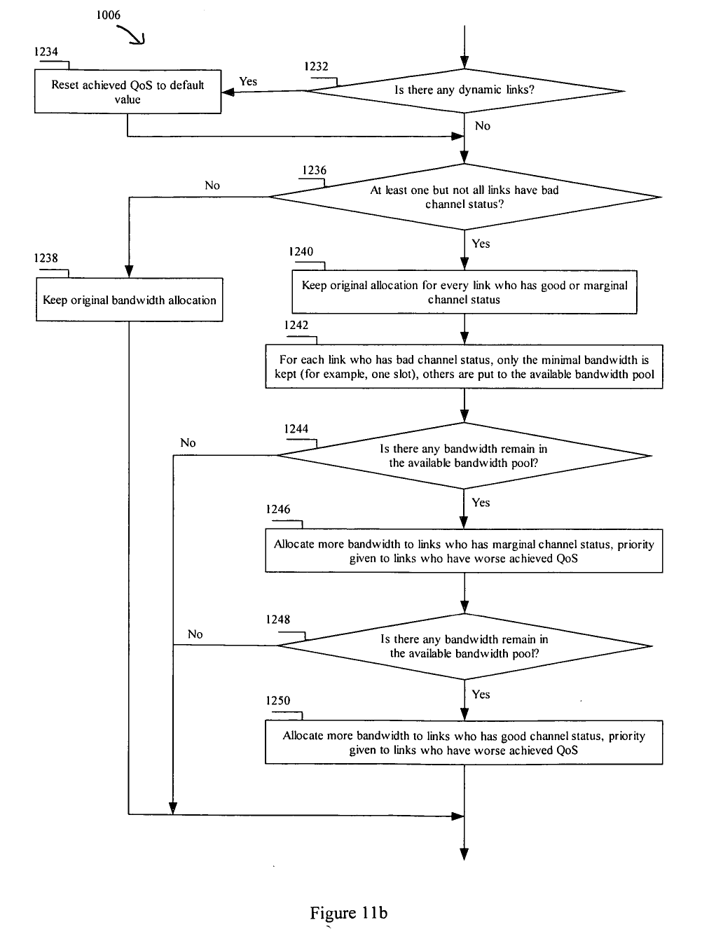

The details of the scheduling scheme running on a wireless terminal are described below with reference to FIG. 9, FIG. 10 and FIG. 11.

The scheduler can determine schedules for each link based on the global link information. The channel status is the highest priority in the scheduling procedure. When the channel status is in the good mode, the bandwidth reservation based on its QoS requirement of a link can be guaranteed. When the channel status is in the marginal mode, the bandwidth reservation based on its QoS requirement of a link can be guaranteed as possible as it can be. When the channel status is in the bad mode, the service to a link can be reduced to the minimal, while compensation can be made whenever possible without hurting the services to links with the good mode status.

Referring to FIG. 9, a flowchart illustrating the main control flow of the DISCO scheme is shown. After initialization step 1001 (which will be described in detail below), a link information message can be formed (step 1002). The wireless terminal can then broadcast the link information message as shown in step 1003. Next, the wireless terminal can overhear and retrieve link information for all links and update this information to the database (step 1004). Thereafter, based on new link information, the wireless terminal can predict channel status in step 1005 and can set up transmission schedules in step 1006 (which will be described in detail below). The wireless terminal can conduct transmission based on the new schedule for all local outgoing links as shown in step 1007. Further, the wireless terminal can monitor link quality information and computes achieved QoS for all local incoming links (step 1008) and then goes back to step 1002. This procedure can continue until the wireless terminal breaks all local links or powers off.

FIG. 10 is a flowchart of the initialization procedure (step 1001) of the DISCO scheme of FIG. 10. System parameters (such as thresholds) can be initialized in step 1102. After this step, original bandwidth can be reserved for every local link and the reservation information can be recorded by the wireless terminal (step 1104). In a TDMA scheme, a frame is generally defined for bandwidth allocation. The frame is slotted, while the bandwidth is allocated to each wireless terminal in terms of number of slots and the locations of the slots. It is assumed that there is a bandwidth reservation mechanism for original bandwidth allocation. Further, the wireless terminal can keep monitoring link and its reservation information until there is no change in the network for a period of time (step 1106). The channel status for every link can finally be set as the good mode as shown in step 1108.

FIG. 11a shows a control flow of the scheduling procedure (step 1006) of the DISCO scheme of FIG. 10. The scheduler keeps original bandwidth allocation to every link that has channel status in the good mode or the marginal mode (step 1220). The scheduler also allocates a minimal bandwidth to every link that has channel status in the bad mode and puts remaining bandwidth of the original bandwidth allocation to an available bandwidth pool (step 1222). The scheduler then checks whether there is a bandwidth in the available bandwidth pool (step 1224). If there is a bandwidth in the available bandwidth pool, the scheduler allocates more bandwidth to links that have channel status in the marginal mode and gives priority to links that have worst achieved QoS (step 1226). The scheduler further checks whether there is a bandwidth in the available bandwidth pool (step 1228). If there is a bandwidth in the available bandwidth pool, it allocates more bandwidth to links that have channel status in the good channel mode and gives priorities to links that have worse achieved QoS (step 1230). In both steps 1224 and 1228, if there is no bandwidth available in the pool, the scheduler leaves the scheduling procedure.

FIG. 11b shows a more detailed control flow of the scheduling procedure (step 1006) of the DISCO scheme of FIG. 10. Initially, the scheduler can check whether there is any link joining or leaving the channel (step 1232). If there is a link, the scheduler can reset the achieved QoS to make a fair computation as shown in step 1234. Next, the scheduler can check whether the channel status of at least one link (but not all) has the bad mode (step 1236). If the condition is not satisfied, the scheduler can use original bandwidth allocation for all links as shown in step 1238. Otherwise, the scheduler can keep original allocations for all links with the good channel status and the marginal channel status (step 1240). For all links with the bad channel status, the scheduler can only allocate the minimal bandwidth to these links and allocate the remainder of the original allocation to the available bandwidth pool (step 1242). Thereafter, the scheduler can check whether there is a bandwidth available in the pool as shown in step 1244. If there is bandwidth available, the scheduler can allocate it to the links that have the marginal channel status and can give a higher priority to a link which has worse achieved QoS (step 1246). If there is a bandwidth left in the pool (step 1248), the scheduler can allocate the remaining bandwidth to links that have the good channel status and can give a higher priority to a link which has worse achieved QoS (step 1250). In steps 1246 and 1250, the system parameters can be defined to identify how much bandwidth should be allocated to each link.

When each wireless terminal invokes the scheduling scheme, all wireless terminals can run the same scheduling scheme based on the same initial parameters and system parameters. Therefore, all wireless terminals can obtain the same scheduling results for all links. Each wireless terminal can then transmit packets for its local outgoing links based on these results.

When the scheme is invoked, each wireless terminal is assumed to have global link information. However, at some scheduling time points, some wireless terminals may only obtain partial link information, and the scheduling results may be inconsistent for all wireless terminals. In this situation, the system is not convergent. However, since the information is periodically broadcast and the link information is repeated, all wireless terminals can eventually obtain global link information and the system can be convergent.

As stated above, the scheduler is invoked periodically. The scheduling period is important for the scheme. If the scheduling period is too long, then the predicted channel status is outdated for the scheduling. If the scheduling period is too short, then the overhead is very high. In general, the scheduling period should be selected such that within such period the channel status and the network topology keep stationary. In a TDMA system, a super frame is generally defined as a bandwidth allocation boundary. The period that lasts one or several super frames is therefore defined as the scheduling period.

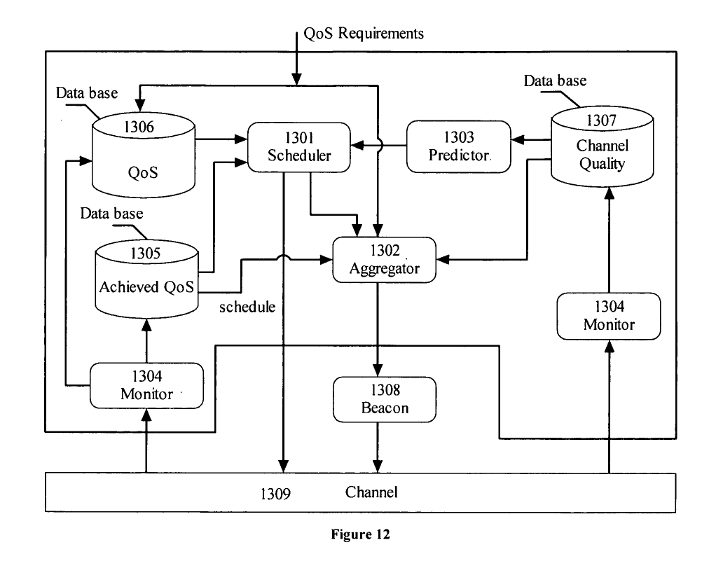

Taking WiMedia MAC as an example, the integration of the method to the protocol is discussed below. Referring to FIG. 12, both outgoing and incoming processing units are integrated as one system. The system may include a scheduler 1301, a message aggregator 1302, a channel status predictor 1303, a channel status monitor 1304, and databases 1305, 1306 and 1307 in the illustrated embodiment. A beacon module 1308 is provided by the WiMedia MAC. In the present embodiment, the QoS requirements are the number of slots required by links. The link information message is aggregated in the aggregator and broadcast through the beacon module by application specific information element (ASIE) functionalities. The beacon message is always broadcast at a lowest data rate and with the largest power. The wireless terminal monitors the channel status and computes achieved throughputs by overhearing. The DRP is responsible for original bandwidth reservation. The scheduler can change the allocated slots of the DRP reservation to adjust bandwidth allocation. The scheduling scheme is invoked in each super frame.

Although the present invention has been described with reference to preferred embodiments, workers skilled in the art will recognize that changes may be made in form and detail without departing from the spirit and scope of the invention. In addition, the embodiments are not to be taken as limited to all of the details thereof as modifications and variations thereof may be made without departing from the spirit or scope of the invention.

We claim:

1. A method of distributed intelligent scheduling with compensation optimization (DISCO) for a wireless ad hoc network or a personal area network comprising scheduling packet transmissions for a plurality of links within the network based on link information which includes QoS requirement, achieved QoS and channel status for the links, wherein the channel status is classified as a good mode, a bad mode and a marginal mode based on successful packet transmission probability, and wherein the successful packet transmission probability of the good mode is greater than the successful packet transmission probability of the marginal mode, and the successful packet transmission probability of the marginal mode is greater than the successful packet transmission probability of the bad mode.

2. The method of claim 1 comprising re-scheduling a transmission opportunity to a first link having the channel status in the good mode or in the marginal mode from a second link if the channel status of the second link is in the bad mode.

3. The method of claim 1 comprising resuming a transmission opportunity to one of the links when the channel status of the link recovers from the bad mode to the good mode or the marginal mode.

4. The method of claim 1 comprising scheduling a minimal bandwidth to one of the links when the channel status of the link is in the bad mode.

5. The method of claim 1 comprising scheduling more bandwidth to a link when the channel status of the link is in the marginal mode.

6. The method of claim 1 comprising scheduling more bandwidth to a link when the channel status of the link is in the good mode.

7. The method of claim 1 wherein scheduling packet transmission for a plurality of links comprises:
(a) forming a link information message in accordance with the link information which includes the QoS requirement, the achieved QoS and the channel status for the links;
(b) broadcasting the link information message;
(c) overhearing and retrieving the link information from the link information message;
(d) predicting the channel status of the links;
(e) developing a transmission schedule for the links; and
(f) monitoring link quality and computing the achieved QoS for incoming links.

8. The method of claim 7 wherein the act (e) comprises:
(i) keeping original bandwidth allocation to one or more of the links if the one or more links have the channel status in the good mode or the marginal mode;
(ii) allocating a minimal bandwidth to one or more of the links if the one or more links have the channel status in the bad mode;
(iii) placing remaining bandwidth of the original bandwidth allocation with the channel status in the bad mode to an available bandwidth pool;
(iv) checking whether there is bandwidth in the available bandwidth pool;
(v) allocating the bandwidth in the bandwidth pool to the links having the channel status in the marginal mode and giving priority to the links having worse achieved QoS, if there is bandwidth in the available bandwidth pool;
(vi) checking whether there is remaining bandwidth in the available bandwidth pool; and
(vii) allocating the remaining bandwidth in the bandwidth pool to the links having the channel status in the good mode and giving priority to the links having worse achieved QoS, if there is remaining bandwidth in the available bandwidth pool.

9. The method of claim 1 wherein the channel status is classified as:
the good mode if the successful packet transmission probability is greater than 95-99%;
the bad mode if the successful packet transmission probability is less than 90-99%; and
the marginal mode if the successful packet transmission probability is greater than or equal to 90-99% but less than or equal to 95-99%.

10. The method of claim 1 wherein the channel status is classified as:
the good mode if the successful packet transmission probability is greater than 97%;
the bad mode if the successful packet transmission probability is less than 95%; and
the marginal mode if the successful packet transmission probability is greater than or equal to 95% but less than or equal to 97%.

11. The method of claim 1 wherein the channel status is classified as the good mode, the bad mode and the marginal mode based on bit error rate of radio channels of the links.

12. The method of claim 11 wherein the channel status is classified as:
the good mode if the bit error rate is less than about 10⁻⁹ to about 10⁻²;
the bad mode if the bit error rate is greater than about 10⁻⁴ to about 10⁻¹; and
the marginal mode if the bit error rate is greater than or equal to about 10⁻⁹ to about 10⁻² but less than or equal to about 10⁻⁴ to about 10⁻¹.

13. The method of claim 11 wherein the channel status is classified as:
the good mode if the bit error rate is less than about 10⁻⁴;
the bad mode if the bit error rate is greater than about 10⁻²; and
the marginal mode if the bit error rate is greater than or equal to about 10⁻⁴ but less than or equal to about 10⁻².

14. The method of claim 1 wherein the channel status is classified as the good mode, the bad mode and the marginal mode based on signal to noise ratio of radio channels of the links.

15. A system of distributed intelligent scheduling with compensation optimization (DISCO) for a wireless ad hoc network or a personal area network comprising:
(a) a scheduler for developing a transmission schedule for a plurality of links within the network based on link information which includes QoS requirement, achieved QoS and channel status for the links;
(b) a radio channel status predictor for predicting the channel status;
(c) an aggregator for aggregating the QoS requirement, the achieved QoS and the channel status for links as a link information message;
(d) a broadcaster for broadcasting the link information message;
(e) a channel quality monitor for detecting channel quality, computing the achieved QoS, overhearing and collecting the link information; and
(f) a data storage device for storing the link information.

16. The system of claim 15 wherein the aggregator aggregates the QoS requirement for one or more outgoing links, and the achieved QoS and the channel status for one or more incoming links as the link information message.

17. The system of claim 15 wherein the channel quality monitor detects the channel quality and computes the achieved QoS for local incoming links and overhears and collects the link information for local outgoing links.
